(19) United States
(12) Patent Application Publication
(10) Pub. No.: US 2007/0281167 A1
(43) Pub. Date: Dec. 6, 2007

(54) Method for improving cleanability of surfaces

(76) Inventors: Jeffrey Allen Odle, Middletown, DE (US); Eric Guy Sumner, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/810,568

(22) Filed: Jun. 6, 2007

Related U.S. Application Data
(60) Provisional application No. 60/811,645, filed on Jun. 6, 2006.

(51) Int. Cl. B32B 27/32

(52) U.S. Cl. 428/421; 525/104; 528/29

(57) ABSTRACT

A method to improve cleanability of surfaces comprises applying a coating composition to a surface, wherein the composition comprises (a) a cross-linkable fluorotelomer comprising repeat units derived from a fluoroalkene; (b) a moisture-curable silicone; (c) a catalyst; and (d) a solvent to a surface, wherein the solvent is present in an amount such that the coating composition has a VOC content of not greater than 350 g VOC per liter of the composition; and curing the composition.

### CROSS-REFERENCE TO RELATED APPLICATION

This application claims priority to U.S. Provisional Application No. 60/811,645, filed on Jun. 6, 2006.

### FIELD OF THE INVENTION

This invention relates to a method for improving surface cleanability by applying a protective coating on a hard surface.

### BACKGROUND OF THE INVENTION

Current methods of cleaning certain surfaces require use of high pressure washing. Such methods can be very time consuming and costly, especially when contract cleaners are used. Use of excessive water during the pressure washing can also be expensive. Furthermore, environmental regulations may limit the amount of water used in cleaning certain surfaces, such as farm surfaces including surfaces in barns, where animals are housed.

Numerous coating compositions act as sealers for hard surfaces, such as concrete. These are available commercially to protect the surfaces against staining, mold, mildew, etc. Many of these sealers are based on silicones and silicates.

U.S. Pat. No. 6,464,766 discloses a cement composition which comprises polytetrafluoroethylene (PTFE) and one or both of an alcohol-base antifoamer and silicone antifoam. This cement composition has improved strength over cement compositions which comprise PTFE, but lack one or both of the antifoams. The added PTFE reduces dusting. Addition of the antifoam improves strength.

A number of cleaners have been used to clean and disinfect farm surfaces, for example, poultry houses, swineries, livestock barns, farm premises and hatcheries. Improvements to the cleaning process are desired.

### SUMMARY OF THE INVENTION

This invention is directed to a method for improving surface cleanability which comprises applying a coating composition to a hard surface wherein the coating composition comprises (a) a crosslinkable fluorotelomer comprising repeat units derived from a fluoroalkene; (b) a moisture-curable silicone; (c) a catalyst; and (d) a solvent, wherein the solvent is present in an amount such that the coating composition has a VOC content of not greater than 350 g VOC per liter. There is further provided a method for cleaning a surface which comprises (a) applying a coating composition to a hard surface wherein the coating comprises (1) a crosslinkable fluorotelomer comprising repeat units derived from a fluoroalkene; (2) a moisture-curable silicone; (3) a catalyst; and (4) a solvent, wherein the solvent is present in an amount such that the coating composition has a VOC content of not greater than 350 g VOC per liter; (b) soiling the surface; and (c) cleaning the surface.

### DETAILED DESCRIPTION OF THE INVENTION

The present invention is a method to improve cleanability to surfaces which are frequently soiled and/or contaminated, and thus are in need of cleaning and/or disinfecting. The present invention is further directed to a method to clean a surface which has become soiled and/or contaminated. The methods each comprise applying to the surface a coating composition which comprises a crosslinkable fluorotelomer, a moisture-curable silicone, a catalyst and a solvent.

### Cross-Linkable Fluorotelomer

The coating composition of the method of this invention comprises a cross-linkable fluorotelomer, which may be based on any fluoroalkene repeating unit that can produce a fluorotelomer having the properties disclosed herein can be used. In one embodiment, the fluoroalkene monomer contains 2 to about 10, and in another, 2 to 3, carbon atoms. Examples of suitable fluoroalkenes include, but are not limited to, 1,1-difluoroethylene, 1,2-difluoroethylene, tetrafluoroethylene (TFE), 3,3,3-trifluoropropene, hexafluoropropylene (HFP), and combinations of two or more thereof. In a particular embodiment, the fluoroalkene is TFE.

In one embodiment, the fluorotelomers are homotelomers. In another embodiment, a cotelomer (copolymer) containing repeat units derived from a comonomer can also be produced. The comonomer is generally an ethylenically unsaturated compound, which can be fluorinated or perfluorinated. In an embodiment, the amount of repeat units derived from a comonomer can be in the range of from about 0.1 to about 10, and in another embodiment, 0.3 to 3.0 weight % of the copolymer.

Suitable comonomers include, but are not limited to, ethylene, propylene, butylene, decene, 1,1-difluoroethylene, 1,2-difluoroethylene, TFE, 3,3,3-trifluoropropene, HFP, and combinations of two or more thereof. The preferred comonomers are perfluorinated comonomers. Preferred comonomers are TFE, HFP, or combinations thereof.

The fluorotelomer is cross-linkable, meaning, a cross-link feature has been designed into its structure. One example of a cross-linkable fluorotelomer has an end group derived from a secondary alcohol or derivative thereof, as disclosed in U.S. Pat. No. 6,596,829.

A crosslinkable fluorotelomer can be prepared by a telomerization process. The process may comprises, consists essentially of, or consists of combining a fluoroalkene, and optionally, a comonomer, in a hydrofluorocarbon solvent with a free radical initiator and at least one secondary alcohol or derivative thereof.

A hydrofluorocarbon is used in a process for producing the fluorotelomer of the composition. The hydrofluorocarbon can also be incorporated into the fluorotelomer as an end group. The suitable hydrofluorocarbons include, but are not limited to, any of those disclosed in U.S. Pat. No. 5,310,870. Examples of suitable hydrofluorocarbons include, but are not limited to, 2,3-dihydrodecafluoropentane, perfluorobutyl methyl ether, perfluorobutyl ethyl ether, 2,4-dihydrooctafluorobutane, 1,1,2,3,3,3-hexafluoropropyl methyl ether, 2-trifluoromethyl-2,3-dihydrononafluoropentane, 1,1,1,3,3-pentafluorobutane, or combinations thereof. These hydrofluorocarbons can be obtained commercially. For example, 2,3-dihydrodecafluoropentane is available from E. I. du Pont de Nemours and Company, Wilmington, Del.; and perfluorobutyl methyl ether and perfluorobutyl ethyl ether are available from 3M Company, Minneapolis, Minn.

Essentially any free radical initiator can initiate reaction to produce the fluorotelomers in the presence of a hydrofluorocarbon, fluoroalkene, and secondary alcohol. Preferred free radical initiators are di-tertiary butyl peroxide, tertiary-butyl perbenzoate, tert-amyl peroctanoate, tert-amyl peroxy-2-ethylhexanoate, and azo initiators such as 1,1-azobis(cyanocyclohexane) and most preferred is di-tertiary butyl peroxide. The amount of free radical initiator used preferably falls within the range of 0.4 to 3.0, more preferably 0.7 to 2.5 weight %, based on the weight of the fluoroalkene. Generally, a minor amount of the free radical initiator can also be incorporated into the fluorotelomer. The amount incorporated generally is about the same as, or lower than, that of the hydrofluorocarbon.

A majority of the end groups of the fluorotelomer may be derived from the secondary alcohol or derivative thereof. Particularly suitable secondary alcohol or derivative thereof is one that is substantially soluble in a hydrofluorocarbon disclosed herein. In one particular embodiment, the secondary alcohols used are those having at least 4 to about 12 carbon atoms and an α-hydrogen. The end group can also be derived from a derivative of a secondary alcohol. The derivative of suitable secondary alcohol can include an ether or ester of a secondary alcohol or combinations thereof. Also suitable are combinations of a secondary alcohol, an ether thereof, and/or an ester thereof. Particular examples of suitable secondary alcohols of some embodiments include, but are not limited to, 2-propanol, 2-butanol, 2-pentanol, 2-hexanol, 2-heptanol, 2-butylacetate, cyclohexanol, 1-methoxy-2-propanol, 1-methoxy-3-butanol, 1-methoxy-2-pentanol, 1-methoxy-2-propanol acetate ester, and combinations of two or more thereof. In other embodiments, 2-butanol, 2-pentanol, or combinations thereof, are used.

The amount of secondary alcohol can be that which produces a fluorotelomer with a number average molecular weight in the range of from about 1,800 to 75,000 in one embodiment, and from about 3,000 to 30,000 in another. For example, the amount of secondary alcohol can be between about 0.1 to about 5, preferably about 0.3 and about 5, and preferably 2.5 to 4.0 mole %, based on the total number of moles of fluoroalkene.

After the telomerization process, the fluorotelomer is generally dispersed as a suspension or emulsion in the hydrofluorocarbon and is recoverable in that form by filtration or other means. The dispersion can contain from about 5-20 weight % of the fluorotelomer, with dispersions of high molecular weight fluorotelomers falling at the low end of this range. If desired, the fluorotelomers can also be dispersed in other solvents such as isopropanol or water.

The molar ratio of the repeat units derived from the fluoroalkene to the secondary alcohol or its derivative end group can be in the range of from about 18:1 to about 500:1, preferably about 120:1 to about 150:1. The molar ratio of the repeat units derived from the fluoroalkene to the hydrofluorocarbon end group can be in the range of from about 800:1 to about 2500:1, preferably about 2000:1 to about 2400:1.

The crosslinkable fluorotelomer can have or comprise a structure depicted as either H(CX₂)ₚB_{q}Dᵣ or a mixture of H(CX₂)ₚB_{q} and H(CX₂)ₚDᵣ. In the formulae, X is H or F in which, in some embodiments, at least 80% is F, in other embodiments, at least 90% is F, and in still other embodiments, at least 99% is F; p is a number from about 36 to about 1500, preferred 60 to 600; B denotes any repeat units derived from a hydrofluorocarbon; q is a number from 0.02 to 0.4; D represents the end group derived from a secondary alcohol or its derivative; and r is a number from 0.2 to 1.0.

The crosslinkable fluorotelomer is typically present in the coating composition in an amount of 0.1 to about 30 weight % based on the total weight of the coating composition.

### Moisture-Curable Silicone

The term “moisture-curable silicone” refers to silicone resin, silicone gum, silicone fluid, or combinations of two or more thereof wherein the silicone is moisture-curable. By “moisture-curable”, it is meant that the silicone hydrolyzable terminal groups, such as, for example, alkoxy, carboxy, and amino groups. It is recognized that moisture-curable silicones may comprise non-hydrolyzable terminal groups, such as hydroxy groups. However, the number of non-hydrolyzable terminal groups remains below the limit at which the silicone would no longer be moisture-curable. Such silicones are known in the art and are generally available commercially, for example, from Wacker Silicones, Adrian, Mich. (a division of Wacker-Chemie GmbH, Munich, Germany), Dow Corning, Midland, Mich. and General Electric Company, Fairfield, Conn. The silicones also can be produced by any methods known to one skilled in the art. For example, the silicone can comprise fragments having the structure

—(R₃SiO_{0.5})ₘ(R₂SiO)ₙ(RSiO_{1.5})ₚ(SiO₂)_{q}—

where each R can be the same or different and is independently selected from the group consisting of hydrogen, a hydrocarbon radical of 1-20 carbon atoms, and combinations of two or more thereof. The radicals can include alkyls, alkenyls, and aryls such as methyl, ethyl, propyl, butyl, vinyl, allyl, phenyl, and combinations of two or more thereof. The subscripts m, n, p, and q comprise the molar ratio of the units with the sum of m, n, p, and q equaling to 1. It can also be a mixture of resins. Generally, at least one of the R groups is phenyl such as, for example, (MePhSiO_{2/2}), (PhSiO_{3/2}), (Ph₂SiO_{2/2})—. An example of a moisture-curable silicone is methoxy-terminated methyl phenyl silicone.

Suitable moisture-curable silicones include polyorganosiloxanes such as, for example, alkoxy-terminated polyalkylsiloxanes and amino-terminated polyalkylsiloxanes, and combinations of two or more thereof. Examples of suitable polyorganosiloxanes include, but are not limited to, polydimethylsiloxanes, polymethylhydrogensiloxanes, polysilsesquioxanes, polytrimethylsiloxanes, polydimethylcyclosiloxanes, and combinations of two or more thereof which are alkoxy-, especially, methoxy-terminated.

Each moisture-curable silicone can also contain functional groups such as halide, amine, hydroxy, epoxy, carbinol, carboxylate, acetoxy, alkoxy, acrylate, and combinations of two or more thereof. The molecular weight can be in the range of from about 500 to about 1,000,000.

The moisture-curable silicone is typically present in the coating composition in an amount of about 5 to about 20 weight %, based on the total weight of the coating composition.

### Catalyst

Any catalyst that can catalyze or enhance the curing of a coating composition disclosed above can be used herein. Examples include, but are not limited to, zirconium or titanium or those expressed by the formula M(OR²)₄ where M is zirconium or titanium and each R² is individually selected from an alkyl, cycloalkyl, alkaryl, hydrocarbon radical containing from about 1 to about 30, or from about 2 to about 18, or from about 2 to about 12 carbon atoms per radical and each R² can be the same or different. Catalysts of the formula M(OR²)₄ are particularly suitable because they also function as a crosslinking agent which is compatible with the secondary alcohol or derivative thereof end groups on the crosslinkable fluorotelomer.

Specific examples of catalysts include, but are not limited to, zirconium acetate, zirconium propionate, zirconium butyrate, zirconium hexanoate, zirconium 2-ethyl hexanoate, zirconium octanoate, tetraethyl zirconate, tetrapropyl zirconate, tetraisopropyl zirconate, tetrabutyl zirconate, titanium acetate, titanium propionate, titanium butyrate, titanium hexanoate, titanium 2-ethyl hexanoate, titanium octanoate, tetraethyl titanate, tetrapropyl titanate, tetraisopropyl titanate, tetrabutyl titanate, and combinations of two or more thereof. In particular embodiments, the catalyst is a crosslinking agent and is tetraisopropyl titanate, tetrabutyl titanate, or a combination thereof.

Other suitable catalysts include, without limitation, a Group VIII metal such as platinum, palladium, iron, rhodium, and nickel, or a complex thereof. Catalysts including, without limitation, zinc, tin and zirconium, and complexes thereof, are also suitable catalysts. Examples of still other suitable catalysts include, but are not limited to, dibutyltin diacetate, dibutyl dilaurate, zinc acetate, zinc octanoate, and combinations of two or more thereof. For example, dibutyltin diacetate can be used independently or in combination with a titanium compound.

Each of the catalysts disclosed above can be present in the composition in an amount in the range of from about 0.001 to about 10 weight % based on the total weight of the composition.

### Solvent

The solvent in the coating composition can be or comprise aromatic hydrocarbon, alkane, alcohol, ketone, ester, ether, water, and combinations of two or more thereof such as, for example, toluene, n-heptane, octane, cyclohexane, dodecane, methanol, ethanol, isopropyl alcohol, acetone, methyl ethyl ketone, dipropylene glycol, dipropylene glycol methyl ether, methyl acetate, ethyl acetate, t-butyl acetate, tetrahydrofuran, dioxane, white spirit, mineral spirits, naphtha, water and combinations of two or more thereof. tT-Butyl acetate and water are preferred.

The solvent is present in an amount that provides a coating composition having a volatile organic compound (VOC) content of no greater than 350 g VOC per liter. Such coating compositions meet VOC emission regulations as set forth by the Environmental Protection Agency (EPA) under the Clean Air Act. Examples of solvents which do not contribute to VOC of the composition include water, acetone, methyl acetate, and t-butyl acetate. The solvent may also consist of water

### Silicone Intermediate

Optionally, a silicone intermediate may also be present. For purpose of distinguishing the moisture-curable silicone from silicone intermediate, the silicon intermediate refers herein to silicones such as polyorganosiloxanes, not moisture-curable, such as, for example, hydroxy-terminated polyorganosiloxane. It is recognized that non-moisture-curable silicones may comprise hydrolyzable terminal groups, such as methoxy groups. However, the number of hydrolyzable terminal groups remains below the limit at which the silicone would be moisture-curable. Examples of polyorganosiloxanes include, but are not limited to, polydimethylsiloxanes, polymethylhydrogensiloxanes, polysilsesquioxanes, polytrimethylsiloxanes, polydimethylcyclosiloxanes, and combinations of two or more thereof which are hydroxyl-terminated.

A silicone intermediate may also be or comprise a volatile siloxane. The term “volatile siloxane” refers to a siloxane exhibiting volatility (the property of vaporizing readily under given temperature and pressure conditions) under the temperature and pressure of use. Typically, a volatile siloxane has an evaporation rate of more than 0.01 relative to n-butyl acetate which has an assigned value of 1. A volatile siloxane can have the formula of R¹(R¹₂SiO)ₓSiR¹₃ or (R¹₂SiO)_{y} where each R¹ can be the same or different and can be an alkyl group, an alkoxy group, a phenyl group, a phenoxy group, or combinations of two or more thereof; having 1 to about 10 or 1 to about 8 carbon atoms per group. R¹ can also be a substituted alkyl group. For example, R¹ can be a methyl group or higher alkyl and can be substituted with a halogen, an amine, or other functional group. Subscript x can be a number from about 1 to about 20 or from about 1 to about 10 and y can be a number from about 3 to about 20 or from about 3 to about 10. Such volatile siloxane can have a molecular weight in the range of from about 50 and to about 1,000 and a boiling point less than about 300° C.

The optional (non-moisture-curable) silicone is typically present in the coating composition in an amount of less than about 2 weight %, based on the total weight of the composition.

### Additional Components

The coating composition can further comprise additional components such as modified fumed silica, surfactants, fluoropolymers such as polytetrafluoroethylene, waxes, fatty acids such as stearic acid, fatty acid salts such as metal stearates, finely dispersed solids such as talc, emulsifiers, biocides, corrosion inhibitors. These are typically present in an amount of 0.01 to about 10 weight % based on the total weight of the composition.

The coating composition can be produced by any means known to one skilled in the art such as, for example, mixing together each component disclosed above.

### Methods

The present invention is directed to a method which comprises applying a coating composition to a hard surface to improve cleanability of the surface. The coating composition comprises (a) a crosslinkable fluorotelomer comprising repeat units derived from a fluoroalkene; (b) a moisture-curable silicone; (c) a catalyst; and (d) a solvent. The method further comprises a curing step.

In another embodiment, this invention provides a method for cleaning a surface which comprises (a) applying a coating composition to a hard surface wherein the coating comprises (1) a crosslinkable fluorotelomer comprising repeat units derived from a fluoroalkene; (2) a moisture-curable silicone; (3) a catalyst; and (4) a solvent, wherein the solvent is present in an amount such that the coating composition has a VOC content of not greater than 350 g VOC per liter; (b) curing the composition; (c) soiling the surface; and (d) cleaning the surface.

Application of the composition to a hard surface can be carried out by any means known to one skilled in the art such as, for example, spraying, brushing, rolling, wiping, dipping, and combinations of two or more thereof. Preferably, the coating is applied by spraying as this consumes less time than rolling or some of the other methods of application. The coating composition may be applied as a single layer coating or as two or more layer coatings. The composition may also be combined with commercial products for treating surfaces.

Curing is performed in a moisture-containing atmosphere. Curing can be carried out by any means known to one skilled in the art such as curing at ambient temperature such as from about 25° C. to about 200° C. under a pressure that accommodates the temperature range such as, for example, atmospheric pressure for about one second to about 2 hours.

As an example of soiling a surface is contemplated food deposits, animal wastes, including urine and feces, mildew, mold, bacteria. Application of the coating composition described herein improves cleaning of so soiled surfaces, such as those which may be present in poultry houses, swineries, livestock barns, farm premises and hatcheries.

Performance of any cleaner or disinfectant may be enhanced when used in the method to clean a surface according to this invention. Examples of cleaners and disinfectants include those based on water, such as using high pressure water, or cleaners, such as Universal Barn Cleaner™, available from E. I. du Pont de Nemours and Company, Wilmington, Del.

Hard surfaces include porous mineral surfaces and various other surfaces having porosity. Such surfaces are preferably selected from the group consisting of include stone (including granite and limestone), masonry, cement, concrete (including unglazed concrete), tile (including unglazed tile), brick, porous clay, grout, mortar, marble, statuary, glass, monuments, wood composite materials (including terrazzo), gypsum board (including that used in wall and ceiling panels), and metals (such as aluminum and steel). Steel includes, but is not limited to galvanized steel, stainless steel, and carbon steel. An especially suitable surface for the method of this invention is concrete or cement. The treated surfaces may be used in the construction of buildings, roads, parking ramps, driveways, floorings, fireplaces, fireplace hearths, counter tops, and other decorative uses in interior and exterior applications.

The coating composition protects surfaces by preventing foreign matter from sticking to surfaces coated with the composition. Foreign matter may comprise one or more of soil, stain, food particles, and the like.

Application of the coating composition to hard surfaces imparts improved cleanability to the surfaces. The methods of this invention reduce the biochallenge of the treated surface, meaning, the amount of bacteria and biological soils present on a treated surface is lower than on a comparable untreated surface. The methods of this invention are especially suitable for use on surfaces such as concrete, steel and cement.

### EXAMPLES

### Example 1

Glazed ceramic tiles, approximately 6 inches (15 cm) square were coated with the Example coating composition described in Table 1 on the unglazed side of the tile. Cleanability after soiling was determined and compared to untreated tile. The coating composition was prepared by simple mixing of the ingredients. The coating composition was applied to the tiles to be treated and tiles allowed to cure (dry) overnight under ambient conditions.

TABLE 1
Example Composition

| Ingredient | Amount, % |
|---|---|
| Silres ® MSE 100 silicone | 9 |
| resin | |
| Dow Corning ® Z-6018 | 2 |
| silicone intermediate | |
| Dow Corning 9770 reactive | 1 |
| silicone oil | |
| t-Butyl acetate | 76. |
| Cross-linkable | 10 |
| polytetrafluoroethylene, 25% | |
| in isopropanol | |
| Tetrabutyl titanate | 1 |
| Cab-O-Sil ™ fumed silica | 0.05 |

Silres® MSE 100 silicone resin, is available from Wacker Silicones, Adrian, Mich. Cross-linkable polytetrafluoroethylene, 25% in isopropanol; tetrabutyl titanate is available from E. I. du Pont de Nemours and Company, Wilmington, Del. Dow Corning® Z-6018 silicone intermediate and Dow Corning 9770 reactive silicone oil are available from Dow Corning, Midland, Mich. Cab-O-Sil™ fumed silica is available from Cabot Corporation, Boston, Mass.

The treated and untreated tiles were soiled as follows. A soiling composition was prepared by mixing in a blender for 10 minutes, 8 g of light loose soil, 8 g of egg white, and 84 g of isopropanol. After blending, the composition was transferred to a beaker and stirred using a magnetic stir bar on high setting. The soiling composition was transferred to a spray container and sprayed onto the tiles in an amount of about 5 g of soiling composition per tile.

The tiles were cleaned using water or Universal Barn Cleaner™, available from E. I. du Pont de Nemours and Company, Wilmington, Del., designated as “UBC” in Table 2, below. The cleaner was applied to the tile and rinsed after 2 minutes using water trigger sprayer, then rinse under flowing tap water.

% Clean was determined as follows. Measurements were taken using a Color Guide Sphere Spex, available from Byk-Gardner USA, Columbia, Md. The instrument provided L, a, b, color values. Five readings of L, a, and b values were recorded for each tile. The values were squared and added together, to provide the “average”. A baseline measurement was taken for a clean tile, where a clean tile is a tile without any treatment or soil. “Dirty” tile is the tile after soiling and cleaning.

$$\% Clean is calculated as follows \text{:} 1 - ( \frac{( average - clean tile )}{( average - dirty tile )} )$$

### The results of cleaning are provided in Table 2. Higher % Clean indicates the cleaner Sample Tiles after the cleaning step.

TABLE 2
Cleaning Performance

| Sample Tile | Coating | Cleaner | % Clean |
|---|---|---|---|
| 1 (Comparative) | Untreated | water | 24.66 |
| 2 (Comparative) | Untreated | UBC | 32.73 |
| 3 | Example Composition | water | 47.71 |
| 4 | Example Composition | UBC | 50.23 |
| 5 | Example Composition | water | 35.88 |
| 6 | Example Composition | UBC | 48.73 |

As can be seen from the results in Table 2, the Sample Tiles treated with the Example Composition were more clean than the untreated Sample Tiles after soiling and cleaning.

### Example 2

Tests were performed at a swine finish house. The Example Composition from Example 1 was applied using a standard 9 inch paint roller with ⅜ inch nap. The Composition was applied on concrete block walls and slatted concrete flooring. The Composition was applied to 4 pens and compared to 4 untreated equal-sized pens. The Composition was allowed to cure for several days prior to a new rotation of hogs being brought into the house. About 6 months later, the hogs were removed and the house cleaned via pressure washing. The time required to clean each pen was recorded. Pens treated with the Example Composition took an average 12 minutes to clean versus 16 minutes for untreated pens. For a typical 36 pen hog house the cumulative savings would be 72 minutes. Using a 2.5 gal/minute (9.5 liters/minute), 3000 psi (20 MPa) power washer, a savings of 180 gallons water (681 liters of water) can be achieved per cleaning.

### Example 3

The right half of one side of a concrete paver was treated with the Example Composition listed in Example 1 and the left half was left untreated. A solution of carboxylate modified FluoSpheres, available from Molecular Probes, Eugene, Oreg., a fluorescent dye having similar size and charge as bacteria, was applied to both halves of the paver. The untreated half allowed penetration of the dye into the concrete surface. The treated half of the paver prevented the dye from penetrating the concrete surface, leaving the dye on the surface from which it can easily be removed.

What is claimed is:

1. A method for improving cleanability of a hard surface comprising applying a coating composition which comprises (a) a crosslinkable fluorotelomer comprising repeat units derived from a fluoroalkene; (b) a moisture-curable silicone; (c) a catalyst; and (d) a solvent, wherein the solvent is present in an amount such that the coating composition has a VOC content of not greater than 350 g VOC per liter of the composition; and curing the composition.

2. The method of claim 1 wherein the composition is cured in a moisture-containing atmosphere at a temperature from about 25° C. to about 200° C.

3. The method of claim 1 wherein the fluoroalkene is selected from the group consisting of 1,1-difluoroethylene, 1,2-difluoroethylene, tetrafluoroethylene (TFE), 3,3,3-trifluoropropene, hexafluoropropylene (HFP), and combinations of two or more thereof.

4. The method of claim 3 wherein the fluoroalkene is tetrafluoroethylene (TFE).

5. The method of claim 3 wherein a majority of the end groups of the fluorotelomer are derived from a secondary alcohol or derivative thereof.

6. The method of claim 5 wherein the secondary alcohol is selected from the group consisting of 2-propanol, 2-butanol, 2-pentanol, 2-hexanol, 2-heptanol, 2-butylacetate, cyclohexanol, 1-methoxy-2-propanol, 1-methoxy-3-butanol, 1-methoxy-2-pentanol, 1-methoxy-2-propanol acetate ester, and combinations of two or more thereof.

7. The method of claim 6 wherein the amount of secondary alcohol is that which produces a fluorotelomer with a number average molecular weight in the range of from about 1,800 to 75,000.

8. The method of claim 6 wherein the amount of secondary alcohol is that which produces a fluorotelomer with a number average molecular weight in the range of from about 3,000 to 30,000.

9. The method of claim 5 wherein crosslinkable fluorotelomer is present in the coating composition in an amount of 0.1 to about 30 weight % based on the total weight of the coating composition.

10. The method of claim 1 wherein the moisture-curable silicone comprises fragments having the structure
—(R₃SiO_{0.5})ₘ(R₂SiO)ₙ(RSiO_{1.5})ₚ(SiO₂)_{q}—
where each R can be the same or different and is independently selected from the group consisting of hydrogen, a hydrocarbon radical of 1-20 carbon atoms, and combinations of two or more thereof, and wherein the subscripts m, n, p, and q comprise the molar ratio of the units with the sum of m, n, p, and q equaling to 1.

11. The method of claim 10 wherein at least one of the R groups is phenyl.

12. The method of claim 1 wherein the moisture-curable silicone is present in the coating composition in an amount of about 5 to about 20 weight %, based on the total weight of the coating composition.

13. The method of claim 5 wherein the catalyst has the formula M(OR²)₄ where M is zirconium or titanium and each R² is alkyl, cycloalkyl, alkaryl, or hydrocarbon radical containing from about 1 to about 30 carbon atoms per radical.

14. The method of claim 13 wherein the catalyst is present in the composition in an amount in the range of from about 0.001 to about 10 weight % based on the total weight of the composition.

15. The method of claim 1 wherein the solvent is selected from the group consisting of toluene, n-heptane, octane, cyclohexane, dodecane, methanol, ethanol, isopropyl alcohol, acetone, methyl ethyl ketone, dipropylene glycol, dipropylene glycol methyl ether, methyl acetate, ethyl acetate, t-butyl acetate, tetrahydrofuran, dioxane, white spirit, mineral spirits, naphtha, water and combinations of two or more thereof.

16. The method of claim 15 wherein the solvent comprises t-butyl acetate or water.

17. The method of claim 1 wherein the coating composition further comprises a silicone intermediate.

18. The method of claim 17 wherein the silicon intermediate is or comprises a volatile siloxane.

19. The method of claim 18 wherein the silicone intermediate is present in the coating composition in an amount of less than about 2 weight %, based on the total weight of the composition.

20. The method of claim 1 wherein the coating composition is applied to a hard surface by spraying, brushing, rolling, wiping, dipping, or combinations of two or more thereof.

21. The method of claim 20 wherein the coating composition is applied to a hard surface by spraying.

22. The method of claim 1 wherein the surface is selected from the group consisting of include stone, masonry, cement, concrete, tile, brick, porous clay, grout, mortar, marble, limestone, statuary, glass, monuments, wood composite materials, gypsum board, and metals.

23. The method of claim 22 wherein the surface is concrete or cement.

24. A method for cleaning a surface which comprises (a) applying a coating composition to a hard surface wherein the coating comprises (1) a crosslinkable fluorotelomer comprising repeat units derived from a fluoroalkene; (2) a moisture-curable silicone; (3) a catalyst; and (4) a solvent, wherein the solvent is present in an amount such that the coating composition has a VOC content of not greater than 350 g VOC per liter; (b) curing the composition; (c) soiling the surface; and (d) cleaning the surface.
